(19) United States
(12) Patent Application Publication
(10) Pub. No.: US 2011/0061441 A1
(43) Pub. Date: Mar. 17, 2011

(54) GANTRY STAGE ORTHOGONALITY ERROR MEASUREMENT METHOD AND ERROR COMPENSATION METHOD FOR POSITION PROCESSING

(76) Inventor: Byoung gwan Ko, Seoul (KR)

(21) Appl. No.: 12/844,471

(22) Filed: Jul. 27, 2010

(30) Foreign Application Priority Data
Sep. 14, 2009 (KR) 10-2009-0086527

(51) Int. Cl. G01B 21/00

(52) U.S. Cl. 73/1.79

(57) ABSTRACT

A gantry stage orthogonality error measurement method and error compensation method for homing processing includes: decoding and storing an encoder value of a current position of the Gantry stage that structurally matches an orthogonality; monitoring at least one of (a) sensors for homing processing and (b) encoder index signals respectively set on a master axis and a slave axis of the Gantry stage while the Gantry stage is driven at low speed; and in the event that the index signal is detected, decoding a linear encoder value of at least one of (a) the master axis and (b) slave axis.

### CROSS-REFERENCE TO RELATED APPLICATIONS

The present application claims priority to Application No. 10-2009-0086527, filed in the Republic of Korea on Sep. 14, 2009, which is expressly incorporated herein in its entirety by reference thereto.

### FIELD OF THE INVENTION

The present invention relates to a Gantry stage orthogonality error measurement method and error compensation method for position processing.

### BACKGROUND INFORMATION

Generally speaking, a Gantry stage utilized in semiconductors, FPD equipment or precision machining equipment respectively supports two linear encoders and two motors for detecting two linear motors and respective motor positions that are arranged in a parallel manner and are driven in a unified manner in the direction of the feed shaft, and includes an LM guide for assisting movement and a cross beam that mechanically fastens and connects two linear motors. In attempting to carry out product manufacturing or operations by driving such Gantry stage, after the motor standard or starting position (also referred to as homing processing) is preferentially set, the set position then set as the standard coordinate, and the requisite feed order for the work process is given. Consequently, the degree of precision of the homing processing position and of the repeatability of homing processing becomes capable of significantly affecting the work performance of the stage as well as product quality.

The two separate linear motors in the Gantry stage move according to respective LM guide surfaces. In such case, the setting of two LM guides so as to maintain a perfectly horizontal position becomes substantially impossible when design, processing and assembly tolerances are considered. According to the assembly conditions of the LM guide, the positions of linear motor 1 (referred to as master axis) and linear motor 2 (referred to as slave axis) are placed in twisted positions in an orthogonal direction as far as a or b relative to the drive direction of the Gantry stage, as illustrated in FIG. 3, and these error values are further increased as the size of the stage increases. According to the direction of the LM guide in which the positions of the master and slave axes are located, orthogonality errors occur in an irregular manner, and such orthogonality errors decrease the degree of repeatability of the homing processing of the stage. As seen from a structural standpoint, in the event that the orthogonality errors become severe, modifications to the stage are caused when driving is conducted for long periods. Moreover, from a maintenance/conservation standpoint, the level of wear of each stage component is aggravated and longevity is reduced, thereby increasing maintenance/conservation costs. When seen from a product productivity standpoint, decreased productivity due to an increase in the number of product defects is caused. Consequently, an appropriate compensation method is required in order to minimize orthogonality errors that occur at the time of homing processing.

In order to compensate for orthogonality errors, the size of the orthogonality errors must be measured as a priority.

In general, when a precise position is measured, a laser interferometer is used. As a method for measuring orthogonality errors, such measurement may be conducted by measuring the diagonal length by two laser interferometers, and by then calculating the difference of the two values. However, if this method is used, such use will necessitate excessive cost and time, and operators will experience errors in installation as well as measurement relative to the laser interferometers.

Another method for measuring orthogonality errors, as illustrated in FIG. 2, uses linear encoders and sensors for homing processing or linear encoder index signals that are respectively positioned on the master axis and slave axis. The motors of the master axis and slave axis are respectively caused to move from the limit sensor in the negative direction of the stage towards the positive direction as far as the index position of the first linear encoder or position of the sensor for homing processing. Subsequently, the linear encoder is used to measure the position, and the difference value of the measured value is calculated, thereby providing measurement of orthogonality errors.

Following homing processing, the Gantry stage orthogonality error compensation method either causes the motor on the opposite side to move under conditions in which one axis of the motor is fixated as far as the orthogonality value measured according to the above explanation, or else the two motors are both driven as far as the error value, to achieve the compensation effect.

### SUMMARY

Example embodiments of the present invention relate to a Gantry stage orthogonality error measurement method and error compensation method for homing processing.

Example embodiments of the present invention provide a Gantry stage orthogonality error measurement method and error compensation method for homing processing with an enhanced level of homing processing repeatability and a capability for minimizing orthogonality errors at the time of Gantry stage homing processing used with, e.g., semiconductors, FPD equipment or precision machining equipment.

According to example embodiments of the present invention, a Gantry stage orthogonality error measurement method and error compensation method for homing processing includes: decoding and storing an encoder value of the current position of the Gantry stage that structurally matches an orthogonality; monitoring sensors for homing processing or encoder index signals respectively set on the master axis and slave axis of the Gantry stage while the Gantry stage is driven at low speed; and, in the event that the index signal is detected, decoding the linear encoder value of the master axis or slave axis of the perceived position.

The Gantry stage orthogonality error measurement method and error compensation method for homing processing utilizes encoders and sensors for homing processing set on a stage. Consequently, it is possible to reduce manufacturing costs.

According to an example embodiment of the present invention, a Gantry stage orthogonality error measurement method and error compensation method for homing processing includes: decoding and storing an encoder value of a current position of the Gantry stage that structurally matches an orthogonality; monitoring at least one of (a) sensors for homing processing and (b) encoder index signals respectively set on a master axis and a slave axis of the Gantry stage while the Gantry stage is driven at low speed; and in the event that the index signal is detected, decoding a linear encoder value of at least one of (a) the master axis and (b) slave axis.

A direction perpendicular to a position at which at least one of (a) the sensor for homing processing is set and (b) the encoder index is located on the master axis relative to a driving direction of the Gantry stage may be standardized, and an absolute position of the position at which at least one of (a) the sensor for homing processing is set and (b) the encoder index is located on the slave axis may be measured.

According to an example embodiment of the present invention, a Gantry stage homing processing sensor or encoder index orthogonality position offset measuring method includes: respectively storing current positions of motors on a master axis and a slave axis of the Gantry stage structurally matching the orthogonality; simultaneously driving the motors of the master axis and slave axis at slow speed in one of (a) a negative direction and (b) a positive direction and searching for a limit sensor position in the one of (a) the negative direction and (b) the positive direction; when the motors reach the limit sensor position in the one of (a) the negative direction and (b) the positive direction, causing the motors to stop, then again simultaneously driving the motors at slow speed in one the (a) the positive direction and (b) the negative direction while at least one of (a) sensors for homing processing and (b) first index signals of encoders on the master axis and slave axis are respectively monitored; when at least one of (a) the sensors for homing processing and (b) the first index signals of the encoders on the master axis and slave axis are detected, storing position values of the motors indicating absolute positions of at least one of (a) the sensors for homing processing and (b) the first index signals of the encoders on the master axis and slave axis; and calculating, using the stored motor position values, distances from where the motors began to move to where the sensor positions were detected, and calculating a difference between the calculated distance values.

According to an example embodiment of the present invention, a Gantry stage orthogonality error compensation method for homing processing includes: maintaining a servo amp of a slave axis in a prerun state, thereafter driving only a motor of a master axis at a slow speed in one of (a) a negative direction and (b) a positive direction, and searching for a limit sensor position in the one of (a) the negative direction and (b) the positive direction; when the motor of the master axis reaches the limit sensor position in the one of (a) the negative direction and (b) the positive direction, causing the motor of the master axis to stop, and then driving the motor of the master axis at slow speed in one of (a) the positive direction and (b) the negative direction while monitoring at least one of (a) a sensor for homing processing and (b) an encoder first index signal on the master axis; when at least one of (a) the sensor for homing processing and (b) the encoder first index signal on the master axis is detected, measuring and storing a signal of at least one of (a) the sensor for homing processing and (b) the encoder first index signal on the master axis; causing the motor to move to a position of at least one of (a) the sensor for homing processing and (b) the encoder first index signal on the master axis and setting as a starting point the position of at least one of (a) the sensor for homing processing and (b) the encoder first index signal on the master axis; maintaining a servo amp of the master axis in a prerun state, thereafter driving a motor of the slave axis at slow speed in one of (a) the negative direction and (b) the positive direction, and searching for a limit sensor position in the one of (a) the negative direction and (b) the positive direction; when the motor of the slave axis reaches the limit sensor position in the one of (a) the negative direction and (b) the positive direction, causing the motor of the slave axis to stop, and then again driving the motor of the slave axis at slow speed in one of (a) the positive direction and (b) the negative direction while monitoring at least one of (a) the sensor for homing processing and (b) an encoder first index signal on the slave axis; when at least one of (a) the sensor for homing processing and (b) the encoder first index signal on the slave axis is detected, measuring and storing a position of at least one of (a) the sensor for homing processing and (b) the encoder first index signal on the slave axis; causing the motor of the slave axis to move to the position of at least one of (a) the sensor for homing processing and (b) the encoder first index signal on the slave axis and setting as a starting point the position of at least one of (a) the sensor for homing processing and (b) the encoder first index signal on the slave axis; sending the master axis and the slave axis to the respective starting positions; and at least one of (a) driving the slave axis as far as a measured absolute position and setting a starting point and (b) driving the master axis as far as the measured absolute position and simultaneously sending the master axis and the slave axes to the starting position.

According to an example embodiment of the present invention, a Gantry stage orthogonality error compensation method for homing processing includes: maintaining a servo amp of a slave axis in a prerun state, thereafter driving only a motor of a master axis at slow speed in one of (a) a negative direction and (b) a positive direction, and searching for a limit sensor position in the one of (a) the negative direction and (b) the positive direction; when the motor of the master axis reaches the limit sensor position in the one of (a) the negative direction and (b) the positive direction, causing the motor of the master axis to stop, and then again driving the motor of the master axis at slow speed in one of (a) the positive direction and (b) the negative direction while monitoring at least one of (a) a sensor for homing processing and (b) an encoder first index signal on the master axis; when at least one of (a) the sensor for homing processing and (b) the encoder first index signal on the master axis is detected, measuring and storing a signal of at least one of (a) the sensor for homing processing and (b) the encoder first index signal on the master axis; causing the motor to move to the position of at least one of (a) the sensor for homing processing and (b) the encoder first index signal on the master axis and setting at as starting point the position of at least one of (a) the sensor for homing processing and (b) the encoder first index signal on the master axis; maintaining a servo amp of the master axis in a prerun state, thereafter driving only a motor of the slave axis at slow speed in the one of (a) the negative direction and (b) the positive direction, and searching for a limit sensor position in the one of (a) the negative direction and (b) the positive direction; when the motor of the slave axis reaches the limit sensor position in the one of (a) the negative direction and (b) the positive direction, causing the motor of the slave axis to stop, and then again driving the motor of the slave axis at slow speed in one of (a) the positive direction and (b) the negative direction monitoring at least one of (a) the sensor for homing processing and (b) an encoder first index signal on the slave axis; when at least one of (a) the sensor for homing processing and (b) the encoder first index signal on the slave axis is detected, measuring and storing a position of at least one of (a) the sensor for homing processing and (b) the encoder first index signal on the slave axis; causing the motor of the slave axis to move to the position of at least one of (a) the sensor for homing processing and (b) the encoder first index signal on the slave axis and setting as a starting point the position of at least one of (a) the sensor for homing processing and (b) the encoder first index signal on the slave axis; and setting the stating point of at least one of (a) the master axis and (b) the slave axis at a point as far as an measured absolute position, and sending at least one of (a) the master axis and (b) the slave axis to the starting point.

According to an example embodiment of the present invention, a Gantry stage orthogonality error compensation method for homing processing includes: recording in a storage unit current positions of motors on a master axis and a slave axis, simultaneously driving the motors of the master axis and the slave axis at slow speed in one of (a) a negative direction and (b) a positive direction by a driving unit, and searching for a position of limit sensors in the one of (a) the negative direction and (b) the positive direction; when the motors reach the limit sensor positions in the one of (a) the negative direction and (b) the positive direction, causing the motors to stop, and then again simultaneously driving the motors at slow speed in one of (a) the positive direction and (b) the negative direction while respectively monitoring at least one of (a) sensors for homing processing and (b) first index signals of encoders on the master axis and the slave axis; when at least one of (a) the sensors for homing processing and (b) the first index signals of the encoders on the master axis and the slave axis are detected, measuring by an encoder signal value and storing absolute positions of at least one of (a) the sensors for homing processing and (b) the first index signals of the encoders on the master axis and the slave axis; driving a Gantry stage to the detected position of at least one of (a) the signal of the sensor for homing processing and (b) an index of the master axis; reading a position of the motor on the slave axis and calculating a distance from the current position to the detected position of at least one of (a) the signal of the sensor for homing processing and (b) the encoder on the slave axis; and conducting a comparison with the measured absolute position and driving at least one of (a) the master axis and (b) the slave axis as far as a difference value.

The conducting of the comparison with the measured absolute position and the driving of the at least one of (a) the master axis and (b) the slave axis as far as the difference value may include: driving the slave axis only driven half of an orthogonality error value; and sending the master axis to the index position of at least one of (a) the sensor for homing processing and (b) the encoder on the master axis.

Further features and aspects of example embodiments of the present invention are described in more detail below with reference to the appended Figures.

### BRIEF DESCRIPTION OF THE DRAWINGS

FIG. 1 schematically illustrates a conventional Gantry stage.

FIG. 2 schematically illustrates the sensor position and axis structure of the Gantry stage illustrated in FIG. 1.

FIG. 3 illustrates an instance of the occurrence of an orthogonality error in a Gantry stage.

FIG. 4 is a block diagram of the equipment for controlling homing processing relative to Gantry stage orthogonality error measurement and error compensation according to an example embodiment of the present invention.

FIGS. 5a to 5C illustrate the sequence followed in measuring the absolute position of the Gantry stage sensors according to an example embodiment of the present invention.

FIG. 6 illustrates the orthogonality position offset sign of the Gantry stage according to an example embodiment of the present invention.

FIGS. 7a and 7b illustrate the sequence followed in the method for homing processing relative to Gantry stage orthogonality error compensation according to an example embodiment of the present invention.

FIG. 8 illustrates the Gantry control algorithm provided in the motion control device (by Motion Engineering, Inc.; MEI).

FIG. 9 is a flow chart of the Gantry stage orthogonality error compensation method for homing processing according to an example embodiment of the present invention.

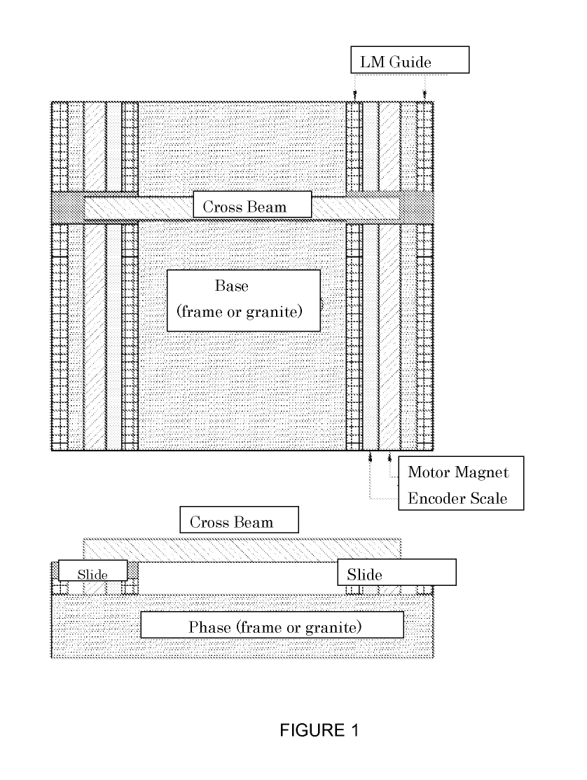

### LIST OF REFERENCE NUMERALS

41 Calculation unit
42 Storage unit
43 Output unit
44 Motor
45 Measurement unit
46 Encoder
47 Monitoring unit
48 Sensor unit

### DETAILED DESCRIPTION

Example embodiments of the present invention provide a Gantry stage orthogonality error measurement method and error compensation method for homing processing with an enhanced level of homing processing repeatability and a capability for minimizing orthogonality errors at the time of Gantry stage homing processing used, e.g., with semiconductors, FPD equipment or precision machining equipment.

Example embodiments of the present invention address the problems related to the Gantry stage orthogonality errors described above. The purpose is, for example, to provide a Gantry stage orthogonality error measurement method and error compensation method for homing processing that uses two linear encoders and two sensors for homing processing or the index position of the linear encoder (respectively set on the master axis and slave axis of the Gantry stage) to measure the orthogonality position error relative to the structurally twisted driving direction of the two motors, thereby providing compensation for such errors.

The Gantry stage orthogonality error measurement method and error compensation method for homing processing includes, for example: decoding and storing an encoder value of the current position of the Gantry stage that structurally matches an orthogonality; monitoring the index signals of sensors for homing processing or encoders respectively set on the master axis and slave axis of the Gantry stage while the Gantry stage is driven at low speed; and, in the event that the index signals are detected, decoding the linear encoder value of the master axis or slave axis of the perceived position.

Moreover, the Gantry stage homing processing sensor or encoder index orthogonality position offset measuring method includes, for example: respectively storing the current positions of the motors on the master axis and slave axis of the Gantry stage structurally matching the orthogonality; simultaneously driving the motors of the master axis and slave axis at a slow speed in the negative direction (or positive direction) and searching for the limit sensor position in the negative direction (or positive direction); when the motors reach the limit sensor position in the negative direction (or positive direction), causing the motors to stop, and then again simultaneously driving the motors at a slow speed in the positive direction (or negative direction) while the sensors for homing processing or the first index signals of the encoders on the master axis and slave axis are respectively monitored; when the sensors for homing processing or the first index signals of the encoders on the master axis and slave axis are detected, storing the position values of the motors indicating the absolute positions of the sensors for homing processing or the first index signals of the encoders on the master axis and slave axis; and using the stored motor position values to calculate the distances from where the motors began to move to where the sensor positions were detected, and calculating the difference between the two calculated distance values.

Further, the direction perpendicular to the point where the sensor for homing processing is set or where the encoder index is located on the master axis relative to the driving direction of the Gantry stage may be standardized, and the absolute position of the position at which the sensor for homing processing is set or where the encoder index is located on the slave axis may be measured.

Moreover, the following may be included in the method: maintaining a servo amp of the slave axis in a prerun state, and thereafter using only the motor of the master axis for driving at slow speed in the negative direction (or positive direction) and searching for the limit sensor position in the negative direction (or positive direction); when the motor reaches the limit sensor position in the negative direction (or positive direction), causing the motor, and then again simultaneously driving the motor at a slow speed in the positive direction (or negative direction) while the sensor for homing processing or the encoder first index signal on the master axis is monitored; when the sensor for homing processing or the encoder first index signal on the master axis is detected, measuring and storing a signal from the sensor for homing processing or the encoder first index signal on the master axis; causing the motor to move to the position of the sensor for homing processing or the encoder first index signal on the master axis and setting this position set as the starting point; maintaining a servo amp of the master axis in a prerun state, and thereafter using only the motor of the slave axis for driving at a slow speed in the negative direction (or positive direction) and searching for the limit sensor position in the negative direction (or positive direction); when the motor reaches the limit sensor position in the negative direction (or positive direction), causing the motor to stop, and then again simultaneously driving the motor at a slow speed in the positive direction (or negative direction) while the sensor for homing processing or the encoder first index signal on the slave axis is monitored; when the sensor for homing processing or the encoder first index signal on the slave axis is detected, measuring and storing the position of the sensor for homing processing or the encoder first index signal on the slave axis; causing the motor to move to the position of the sensor for homing processing or the encoder first index signal on the slave axis and setting this position as the starting point; respectively sending the master axis and slave axis to the starting positions; and driving the slave axis as far as the measured absolute position and setting the starting point or driving the master axis as far as the absolute position and thereafter simultaneously sending both axes to the starting position.

Moreover, the method may include: maintaining a servo amp of the slave axis in a prerun state, and thereafter using only the motor of the master axis for driving at a slow speed in the negative direction (or positive direction) and searching for the limit sensor position in the negative direction (or positive direction); when the motor reaches the limit sensor position in the negative direction (or positive direction), causing the motor, and then again simultaneously driving at a slow speed in the positive direction (or negative direction) while the sensor for homing processing or the encoder first index signal on the master axis is monitored; when the sensor for homing processing or the encoder first index signal on the master axis is detected, measuring and storing a signal from the sensor for homing processing or the encoder first index signal on the master axis; causing the motor to move to the position of the sensor for homing processing or the encoder first index signal on the master axis and setting this position as the starting point; maintaining a servo amp of the master axis in a prerun state, and thereafter using only the motor of the slave axis for driving at a slow speed in the negative direction (or positive direction) and searching for the limit sensor position in the negative direction (or positive direction); when the motor reaches the limit sensor position in the negative direction (or positive direction), causing the motor to stop, and then again simultaneously driving the motor at a slow speed in the positive direction (or negative direction) while the sensor for homing processing or the encoder first index signal on the slave axis is monitored; when the sensor for homing processing or the encoder first index signal on the slave axis is detected, measuring and storing the position of the sensor for homing processing or the encoder first index signal on the slave axis; causing the motor to move to the position of the sensor for homing processing or the encoder first index signal on the slave axis and setting this position as the starting point; and setting the starting point of the master or slave axis at a point as far as the measured absolute position, and sending the master or slave axis to the starting point.

Moreover, the method may include: recording in a storage unit the current positions of the motors on the master axis and slave axis, simultaneously driving the motors of the master axis and slave axis at a slow speed in the negative direction (or positive direction) by a driving unit, and searching for the position of the limit sensors in the negative direction (or positive direction); when the motors reach the limit sensor positions in the negative direction (or positive direction), causing the motors to stop, and then again simultaneously driving the motors at a slow speed in the positive direction (or negative direction) while the sensors for homing processing or the first index signals of the encoders on the master axis and the slave axis are respectively monitored; when the sensors for homing processing or the first index signals of the encoders on the master axis and the slave axis are detected, measuring by an encoder signal value and storing the absolute positions of the sensors for homing processing or the first index signals of the encoders on the master axis and the slave axis; driving a Gantry stage to the detected position of the signal of the sensor for homing processing or index of the master axis; reading the position of the motor on the slave axis and calculating the distance from the current position to the detected position of the signal of the sensor for homing processing or the encoder on the slave axis; and performing a comparison with the measured absolute position, and driving the master axis or slave axis as far as the difference value.

Moreover, when a motion control device (by Motion Engineering, Inc.; MEI) is used, in the step in which a comparison is made with the measured absolute position and the slave axis is offset-driven as far as the difference value, the slave axis is only driven ½ of the orthogonality error value having to be compensated for, the master axis is then sent to the index position of the sensor for homing processing or encoder, and the orthogonality error is compensated for.

As noted above, the Gantry stage orthogonality error measurement method and error compensation method for homing processing is capable of obtaining the following effects.

First, although expensive equipment such as a laser interferometer, absolute position encoder or laser displacement sensor must typically be used in order to measure Gantry stage orthogonality errors, in example embodiments of the present invention encoders and homing processing sensors that are set on the stage are used, thereby providing a reduction in manufacturing costs.

Second, Gantry stage orthogonality errors change in an irregular manner according to where the Gantry axis is placed or when the servo amp is turned on/off. Consequently, the level of repeatability of homing processing also changes. The level of repeatability of homing processing is an important component of indicating the level of performance of the Gantry stage, and this level of homing processing repeatability is able to be improved by the measures described herein.

Third, when the Gantry stage is driven under conditions in which orthogonality errors exist, motor drive characteristics such as the speed ripple, fixation time and level of position precision change with each position according to the conditions of assembly parallelity of the two LM guides on the master axis and slave axis. In the method described herein, such changing characteristics are minimized.

Fourth, when the Gantry stage is driven under conditions in which orthogonality errors exist, frictional force is increased according to the conditions of assembly parallelity of the two LM guides on the master axis and slave axis. Consequently, when the level of wear of the equipment accumulates and becomes severe, the equipment is transformed and the longevity of each element component is reduced. Accordingly, when the method hereof is used, maintenance/conservation costs may be reduced, which is advantageous.

Fifth, if orthogonality errors are minimized when a Gantry stage is used to produce a product, product quality is enhanced and defects are reduced. Consequently, a high level of productivity may be achieved, which is advantageous.

Below, the Gantry stage orthogonality error measurement method and error compensation method for homing processing is described in greater detail with reference to the Figures.

The same reference numbers indicate the same or similar structural components throughout the Figures.

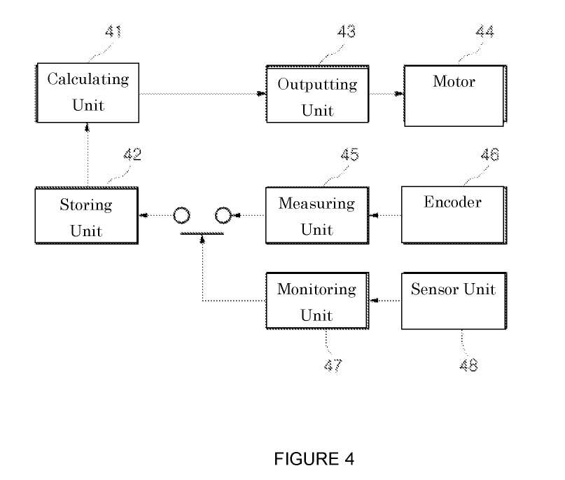

In referring to FIGS. 4 to 9, Gantry stage orthogonality errors are measured through the use of a pair (2) of linear encoders and homing processing sensors or else through the use of the index signals of linear encoders.

In order to measure orthogonality errors through the use of homing processing sensors or the index signals of linear encoders, the set position coordinates of these sensors respectively set on the master axis and slave axis are preliminarily measured.

In the measurement method, the current positions of motors (44) of the master axis and the slave axis are respectively recorded in storing unit (42) under conditions that match the Gantry stage orthogonality as a priority.

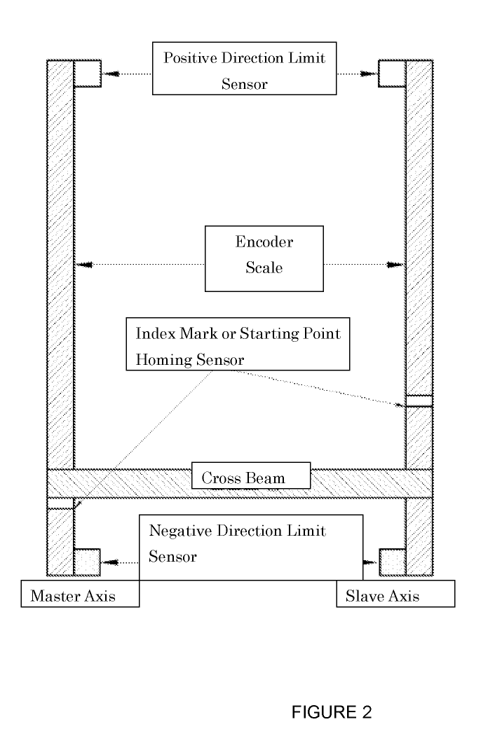

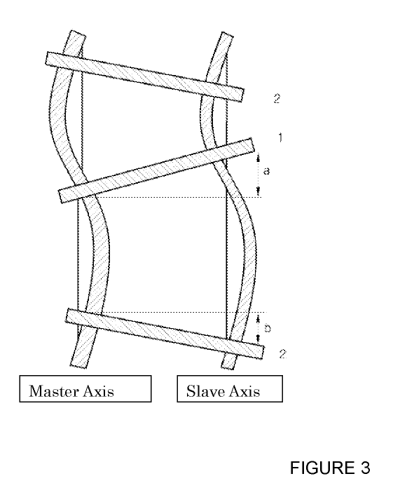

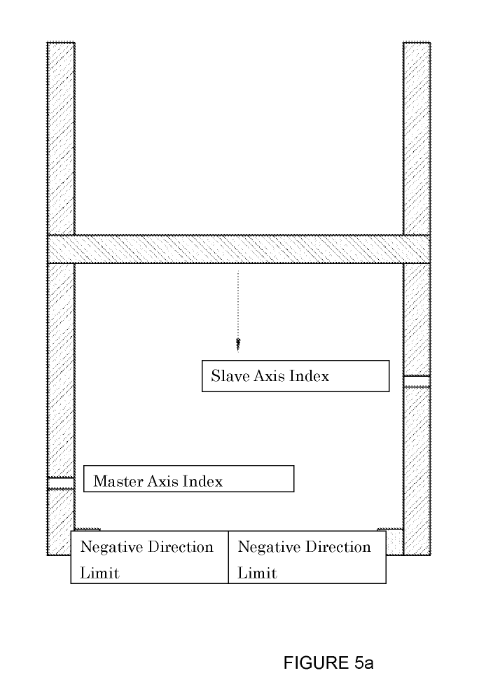

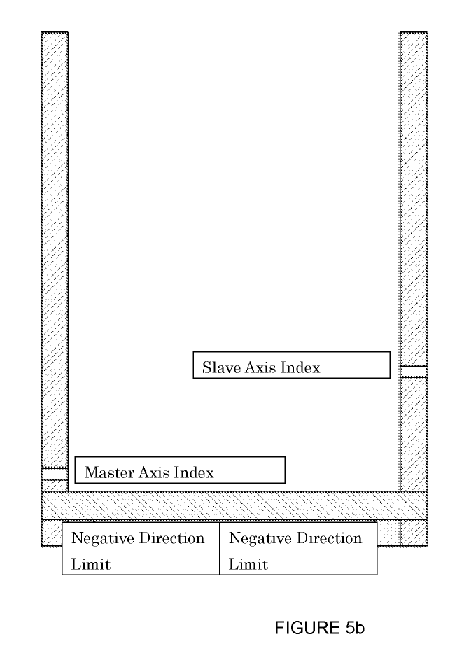

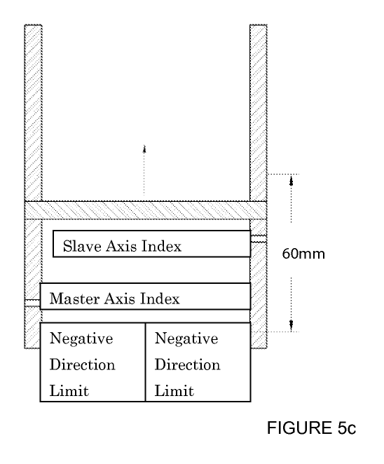

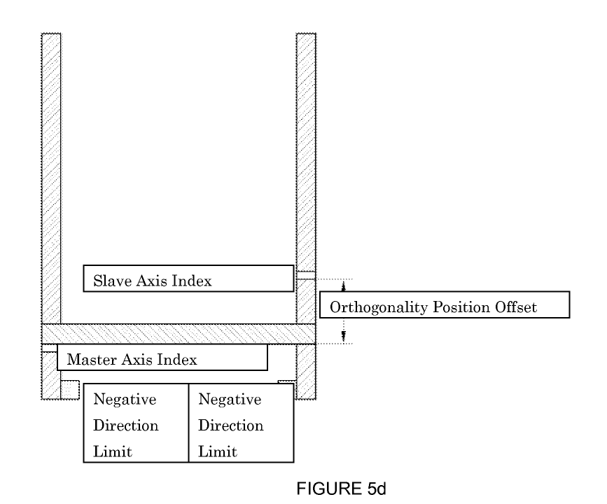

Motors (44) of the master axis and the slave axis are then simultaneously driven (as shown in FIG. 5a) at low speed in the negative direction (or positive direction) by a driving unit, and the limit sensor position of the negative direction (or positive direction) is searched for, as depicted in FIG. 2. This negative direction limit sensor and positive direction limit sensor indicate the maximum range of driving for the stage.

When motors (44) reach the limit sensor position in the negative direction (as depicted in FIG. 5b), motors (44) are caused to stop, and motors (44) are then again simultaneously driven at slow speed in the positive direction (or negative direction) (as depicted in FIG. 5c). At this time, the sensors for homing processing or the first index signals of encoders (46) on the master axis and slave axis are respectively monitored by monitoring unit (47). When the signal is detected by monitoring unit (47), the position of the sensor of sensor unit (48) is measured by measuring unit (45), and this is stored in storing unit (42).

Calculation unit (41) uses the respective stored position values of these motors (44) to calculate the distance from where motors (44) begin to move to where the sensor position is detected, and the difference between the two calculated distance values is again calculated.

The values calculated in this manner indicate the degree to which the positions of the sensors for homing processing or the index of the slave axis have dropped, based on the perpendicular directional shape standard from the positions of the sensors for homing processing or the index of the master axis relative to the Gantry driving direction of the Gantry stage (referred to as orthogonality position offset). Further, the values calculated in this manner are transmitted to motors (44) through output unit (43), thereby providing compensation for the orthogonality errors.

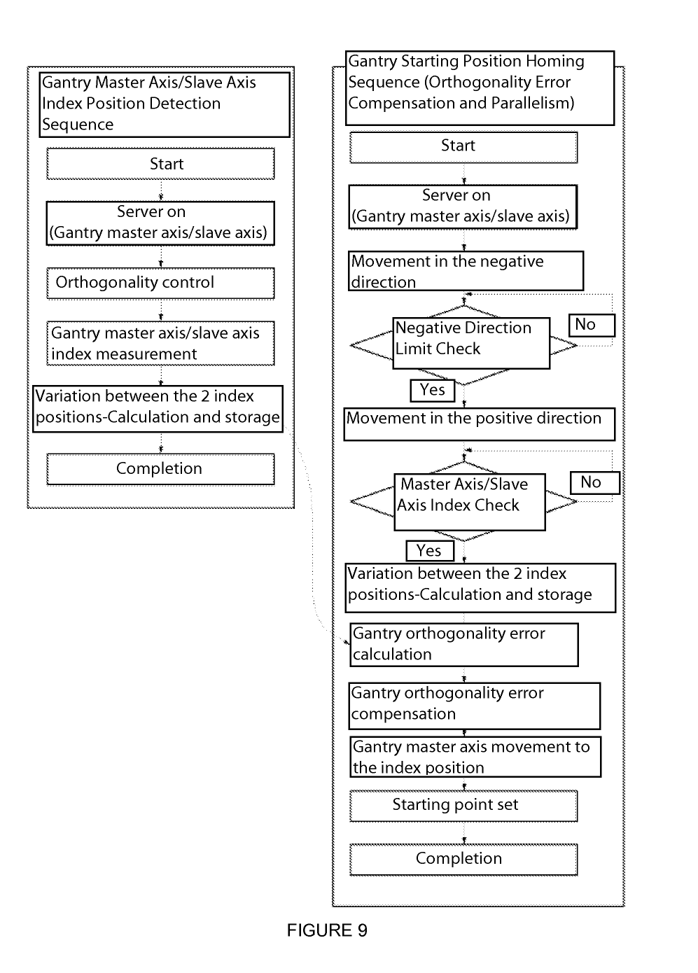

The sequence of the Gantry stage orthogonality error compensation method for homing processing is as depicted in FIG. 9.

The above methods are expressed in formulaic form as follows.

Distance YR from the initial position at which the motor of the master axis begins to move to the position of the homing processing sensor or index is expressed as:

YR=YR_{—}S−YR_{—}E {Formula 1}

The initial position at which the motor of the slave axis begins to move to the position of the homing processing sensor or index is expressed as follows:

YL=YL_{—}S−YL_{—}E {Formula 2}

Orthogonality position offset YO calculated through these values (as depicted in FIG. 5d) is expressed as follows:

YO=YR−YL {Formula 3}

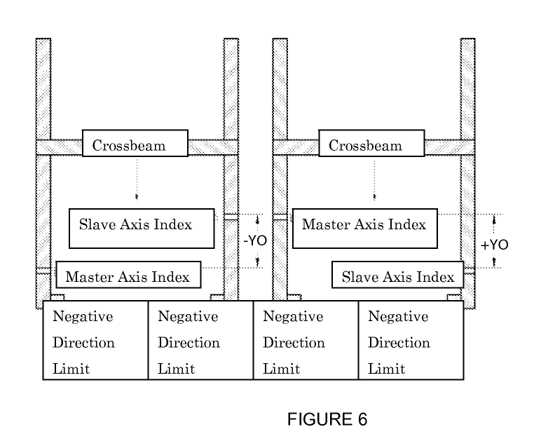

For the symbol used to indicate orthogonality position offset, as noted on the left side of FIG. 6, when the position of the homing processing sensor or the encoder index on the master axis is set farther than the position of the homing processing sensor or the encoder index on the slave axis in the negative directional position relative to the driving direction of the Gantry axis, the negative (−) symbol is used, and when the position of the homing processing sensor or the encoder index on the master axis is set farther than the position of the homing processing sensor or the encoder index on the slave axis in the positive directional position relative to the driving direction of the Gantry axis, the positive (+) symbol is used.

The orthogonality position offset value becomes the manufactured inherent value of the Gantry stage. This value is referenced as the standard orthogonality coordinate value at the time that records are stored in the storing unit or when orthogonality errors are measured.

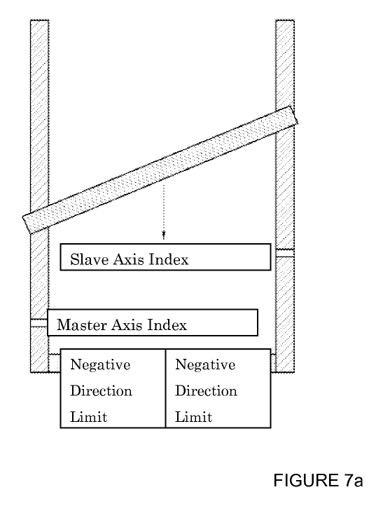

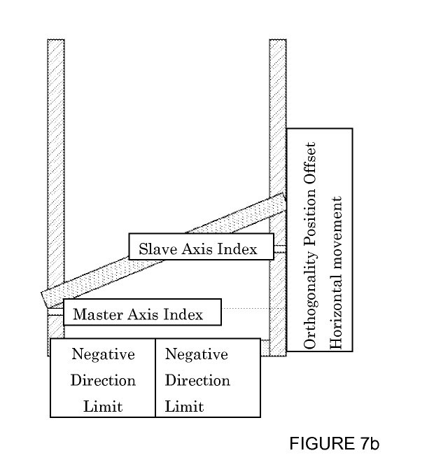

The positions of the motors on the master axis and the slave axis of the Gantry stage are placed in a state in which the orthogonality is twisted, as depicted in FIG. 7a, in an arbitrary position of the Gantry driving direction due to design tolerances as well as processing and assembly errors.

In order to compensate for such orthogonality errors when returning to the starting point, two methods are below.

First is a method in which homing processing is respectively conducted of the master axis and the slave axis in a separate manner (applicable when synchronous control or command following methods are utilized).

Second is a method in which homing processing of the master axis and slave axis is simultaneously conducted (applicable when the cross couple gantry control algorithm is utilized).

When the first method is used, the servo amp of the slave axis is maintained in a prerun state. Subsequently, only the motor of the master axis is used for driving at a slow speed in the negative direction (or positive direction) and the limit sensor position in the negative direction (or positive direction) is searched for.

When the motors reach the limit sensor position in the negative direction, the motors are caused to stop, and are then again simultaneously driven at slow speed in the positive direction (or negative direction). At this time the sensors for homing processing or the first index signals of the encoders on the master axis are monitored by the monitoring unit. When the signals are detected by the monitoring unit, the positions of the sensors are measured by the sensor unit and stored in the storage unit.

After the motors are caused to move to the position of the sensor stored in the manner noted above, the driving unit sets this position as the starting point, as noted in FIG. 7b.

As noted above, after homing processing of the master axis is conducted, homing processing of the slave axis is then conducted according to the identical method.

For example, the servo amp of the master axis is maintained in a prerun state. Subsequently, only the motor of the slave axis is used for driving at slow speed in the negative direction (or positive direction) and the limit sensor position in the negative direction (or positive direction) is searched for.

When the motors reach the limit sensor position in the negative direction, the motors are caused to stop, and are then again simultaneously driven at slow speed in the positive direction (or negative direction). At this time the sensors for homing processing or the first index signals of the encoders on the slave axis are monitored by the monitoring unit. When the signals are detected by the monitoring unit, the positions of the sensors are measured by the sensor unit and stored in the storage unit.

After the premeasured orthogonality position offset value has been used to set the position relative to the stored sensor position as the starting point on the slave axis, the driving unit sends the master axis and slave axis to the respective starting point positions. Consequently, the orthogonality errors are ultimately compensated for. Further, the starting point position YL Home on the slave axis is calculated as follows:

YL_Home=YL_{—}E+YO {Formula 4}

The second method in which the master axis and slave axis are simultaneously driven to conduct homing processing is provided as follows. The degree of preliminary twist in orthogonality compensation is measured according to the same method of measurement as used with the orthogonality position offset described earlier. For example, in the state shown in FIG. 7a, the current positions of the master axis and slave axis are respectively recorded in the storage unit. Subsequently, the motors of the master axis and slave axis are simultaneously driven at slow speed in the negative direction (or positive direction) by the driving unit and the limit sensor position in the negative direction (or positive direction) is searched for.

When the motors reach the limit sensor position in the negative direction, the motors are caused to stop, and are then again simultaneously driven at slow speed in the positive direction (or negative direction). At this time, the sensors for homing processing or the first index signals of the encoders on the master axis and slave axis are respectively monitored by the monitor unit. When the signals are detected by the monitor unit, the positions of the sensors are measured by the sensor unit and stored in the storage unit as the encoder signal value.

When the Gantry is driven by the driving unit to the sensor for homing processing or index signal detection position on the master axis, a state is produced as illustrated in FIG. 7b.

After reading the motor position on the slave axis, the calculation unit calculates the distance YL_D from the current position to the sensor for homing processing or index signal detection position on the slave axis:

YL_{—}D=YL_{—}C−YL_{—}E {Formula 5}

Orthogonality error YE uses the difference value of YL_D and YO calculated previously in {Formula 5} based on the standard of the orthogonality position offset value YO, and is calculated as follows:

YE=YO−YL_{—}D {Formula 6}

After a compensation signal is sent to the motor on the slave axis via the driving unit containing the orthogonality error YE distance calculated as noted above, the master axis and slave axis are set at the respective current positions as their starting points; or else, after the starting points have been set at the positions that have been compensated by the error distance, the master axis and slave axis are sent to their starting point positions, thereby completing homing processing in orthogonality error compensation.

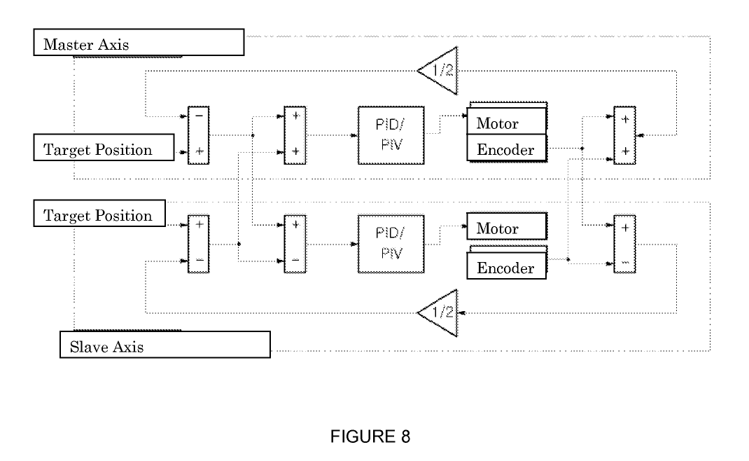

In this process, when the Gantry stage is controlled by using the specialty motion control device by, for example, Motion Engineering, Inc. (MEI), the orthogonality error compensation method explained above must be revised. The real-time torsion error compensation Gantry control algorithm provided by MEI is as illustrated in FIG. 8. In conducting Gantry stage homing processing that uses this algorithm, when the slave axis is moved as far as −YE for orthogonality error compensation, the master axis is also moved as far as −YE by the internal Gantry control algorithm. Accordingly, in conducting compensation in this case, if the orthogonality error value is used to compensate one half of the value calculated above {Formula 6}, the master axis compensates for the remaining half. Therefore, the orthogonality error compensation value must be calculated as noted below to complete homing processing in orthogonality error compensation:

YE=(YO−YL_{—}D)/2 {Formula 7}

While example embodiments of the present invention have been described above, these example embodiments are not intended to be restrictive but are rather used for the purpose of illustration.

What is claimed is:

1. A Gantry stage orthogonality error measurement method and error compensation method for homing processing, comprising:
decoding and storing an encoder value of a current position of the Gantry stage that structurally matches an orthogonality;
monitoring at least one of (a) sensors for homing processing and (b) encoder index signals respectively set on a master axis and a slave axis of the Gantry stage while the Gantry stage is driven at low speed; and
in the event that the index signal is detected, decoding a linear encoder value of at least one of (a) the master axis and (b) slave axis.

2. The method according to claim 1, wherein a direction perpendicular to a position at which at least one of (a) the sensor for homing processing is set and (b) the encoder index is located on the master axis relative to a driving direction of the Gantry stage is standardized, and an absolute position of the position at which at least one of (a) the sensor for homing processing is set and (b) the encoder index is located on the slave axis is measured.

3. A Gantry stage homing processing sensor or encoder index orthogonality position offset measuring method, comprising:
respectively storing current positions of motors on a master axis and a slave axis of the Gantry stage structurally matching the orthogonality;
simultaneously driving the motors of the master axis and slave axis at slow speed in one of (a) a negative direction and (b) a positive direction and searching for a limit sensor position in the one of (a) the negative direction and (b) the positive direction;
when the motors reach the limit sensor position in the one of (a) the negative direction and (b) the positive direction, causing the motors to stop, then again simultaneously driving the motors at slow speed in one the (a) the positive direction and (b) the negative direction while at least one of (a) sensors for homing processing and (b) first index signals of encoders on the master axis and slave axis are respectively monitored;
when at least one of (a) the sensors for homing processing and (b) the first index signals of the encoders on the master axis and slave axis are detected, storing position values of the motors indicating absolute positions of at least one of (a) the sensors for homing processing and (b) the first index signals of the encoders on the master axis and slave axis; and
calculating, using the stored motor position values, distances from where the motors began to move to where the sensor positions were detected, and calculating a difference between the calculated distance values.

4. A Gantry stage orthogonality error compensation method for homing processing, comprising:
maintaining a servo amp of a slave axis in a prerun state, thereafter driving only a motor of a master axis at a slow speed in one of (a) a negative direction and (b) a positive direction, and searching for a limit sensor position in the one of (a) the negative direction and (b) the positive direction;
when the motor of the master axis reaches the limit sensor position in the one of (a) the negative direction and (b) the positive direction, causing the motor of the master axis to stop, and then driving the motor of the master axis at slow speed in one of (a) the positive direction and (b) the negative direction while monitoring at least one of (a) a sensor for homing processing and (b) an encoder first index signal on the master axis;
when at least one of (a) the sensor for homing processing and (b) the encoder first index signal on the master axis is detected, measuring and storing a signal of at least one of (a) the sensor for homing processing and (b) the encoder first index signal on the master axis;
causing the motor to move to a position of at least one of (a) the sensor for homing processing and (b) the encoder first index signal on the master axis and setting as a starting point the position of at least one of (a) the sensor for homing processing and (b) the encoder first index signal on the master axis;
maintaining a servo amp of the master axis in a prerun state, thereafter driving a motor of the slave axis at slow speed in one of (a) the negative direction and (b) the positive direction, and searching for a limit sensor position in the one of (a) the negative direction and (b) the positive direction;
when the motor of the slave axis reaches the limit sensor position in the one of (a) the negative direction and (b) the positive direction, causing the motor of the slave axis to stop, and then again driving the motor of the slave axis at slow speed in one of (a) the positive direction and (b) the negative direction while monitoring at least one of (a) the sensor for homing processing and (b) an encoder first index signal on the slave axis;
when at least one of (a) the sensor for homing processing and (b) the encoder first index signal on the slave axis is detected, measuring and storing a position of at least one of (a) the sensor for homing processing and (b) the encoder first index signal on the slave axis;
causing the motor of the slave axis to move to the position of at least one of (a) the sensor for homing processing and (b) the encoder first index signal on the slave axis and setting as a starting point the position of at least one of (a) the sensor for homing processing and (b) the encoder first index signal on the slave axis;
sending the master axis and the slave axis to the respective starting positions; and
at least one of (a) driving the slave axis as far as a measured absolute position and setting a starting point and (b) driving the master axis as far as the measured absolute position and simultaneously sending the master axis and the slave axes to the starting position.

5. A Gantry stage orthogonality error compensation method for homing processing, comprising:
maintaining a servo amp of a slave axis in a prerun state, thereafter driving only a motor of a master axis at slow speed in one of (a) a negative direction and (b) a positive direction, and searching for a limit sensor position in the one of (a) the negative direction and (b) the positive direction;
when the motor of the master axis reaches the limit sensor position in the one of (a) the negative direction and (b) the positive direction, causing the motor of the master axis to stop, and then again driving the motor of the master axis at slow speed in one of (a) the positive direction and (b) the negative direction while monitoring at least one of (a) a sensor for homing processing and (b) an encoder first index signal on the master axis;
when at least one of (a) the sensor for homing processing and (b) the encoder first index signal on the master axis is detected, measuring and storing a signal of at least one of (a) the sensor for homing processing and (b) the encoder first index signal on the master axis;
causing the motor to move to the position of at least one of (a) the sensor for homing processing and (b) the encoder first index signal on the master axis and setting at as starting point the position of at least one of (a) the sensor for homing processing and (b) the encoder first index signal on the master axis;
maintaining a servo amp of the master axis in a prerun state, thereafter driving only a motor of the slave axis at slow speed in the one of (a) the negative direction and (b) the positive direction, and searching for a limit sensor position in the one of (a) the negative direction and (b) the positive direction;
when the motor of the slave axis reaches the limit sensor position in the one of (a) the negative direction and (b) the positive direction, causing the motor of the slave axis to stop, and then again driving the motor of the slave axis at slow speed in one of (a) the positive direction and (b) the negative direction monitoring at least one of (a) the sensor for homing processing and (b) an encoder first index signal on the slave axis;
when at least one of (a) the sensor for homing processing and (b) the encoder first index signal on the slave axis is detected, measuring and storing a position of at least one of (a) the sensor for homing processing and (b) the encoder first index signal on the slave axis;
causing the motor of the slave axis to move to the position of at least one of (a) the sensor for homing processing and (b) the encoder first index signal on the slave axis and setting as a starting point the position of at least one of (a) the sensor for homing processing and (b) the encoder first index signal on the slave axis; and
setting the stating point of at least one of (a) the master axis and (b) the slave axis at a point as far as an measured absolute position, and sending at least one of (a) the master axis and (b) the slave axis to the starting point.

6. A Gantry stage orthogonality error compensation method for homing processing, comprising:
recording in a storage unit current positions of motors on a master axis and a slave axis, simultaneously driving the motors of the master axis and the slave axis at slow speed in one of (a) a negative direction and (b) a positive direction by a driving unit, and searching for a position of limit sensors in the one of (a) the negative direction and (b) the positive direction;
when the motors reach the limit sensor positions in the one of (a) the negative direction and (b) the positive direction, causing the motors to stop, and then again simultaneously driving the motors at slow speed in one of (a) the positive direction and (b) the negative direction while respectively monitoring at least one of (a) sensors for homing processing and (b) first index signals of encoders on the master axis and the slave axis;
when at least one of (a) the sensors for homing processing and (b) the first index signals of the encoders on the master axis and the slave axis are detected, measuring by an encoder signal value and storing absolute positions of at least one of (a) the sensors for homing processing and (b) the first index signals of the encoders on the master axis and the slave axis;
driving a Gantry stage to the detected position of at least one of (a) the signal of the sensor for homing processing and (b) an index of the master axis;
reading a position of the motor on the slave axis and calculating a distance from the current position to the detected position of at least one of (a) the signal of the sensor for homing processing and (b) the encoder on the slave axis; and
conducting a comparison with the measured absolute position and driving at least one of (a) the master axis and (b) the slave axis as far as a difference value.

7. The method according to claim 6, wherein the conducting of the comparison with the measured absolute position and the driving of the at least one of (a) the master axis and (b) the slave axis as far as the difference value includes: driving the slave axis only driven half of an orthogonality error value; and sending the master axis to the index position of at least one of (a) the sensor for homing processing and (b) the encoder on the master axis.
